(19) United States
(12) Patent Application Publication
(10) Pub. No.: US 2004/0100499 A1
(43) Pub. Date: May 27, 2004

(54) Apparatus, system and method of configuring desktops based on text label directional properties

(75) Inventors: Brandon Brockway, Austin, TX (US); Steven Edward Atkin, Austin, TX (US)

Correspondence Address: Mr. Volel Emile, P.O. Box 202170, Austin, TX, 78720-2170, US

(73) Assignee: International Business Machines Corporation

(21) Appl. No.: 10/302,497

(22) Filed: Nov. 21, 2002

(51) Int. Cl. G09G 5/00

(52) U.S. Cl. 345/765; 345/835

(57) ABSTRACT

A system, apparatus and method of configuring a desktop based on text labels' directional properties are provided. The desktop includes a plurality of icons associated each with a text label. The text labels are used to describe the icons. The system, apparatus and method entail determining the directional property of the text labels and configuring the desktop based on the determined directional property. A different configuration is used for each different directional property. For example, if the directional property of the text labels is from left-to-right a first configuration is used. If instead the directional property of the text labels is right-to-left, a second configuration is used. Further, if the directional property of the text labels is top-to-bottom a third configuration is used.

### CROSS-REFERENCE TO RELATED APPLICATIONS

This application is related to co-pending U.S. patent application Ser. No. _____ (IBM Docket No. AUS920020633), entitled APPARATUS, SYSTEM AND METHOD OF ENABLING A USER TO CONFIGURE A DESKTOP herein, filed on even date herewith and assigned to the common assignee of this application.

### BACKGROUND OF THE INVENTION

1. Technical Field

The present invention is directed to electronic desktops. More specifically, the present invention is directed to an apparatus, system and method of configuring desktops based on script directions.

2. Description of Related Art

At present, the most commonly used user interface paradigm for computing devices is the windows-icons-desktop-folders metaphor prevalent on most personal computer systems. Under this paradigm, the screen of a computer system simulates an office desktop that contains various objects. The objects are represented as graphical “icons” that can be opened as “windows” on the screen. A user can create an unlimited number of overlapping windows, and the size of the windows can be adjusted dynamically. The user can also hierarchically create and manipulate “folders” that reflect how the information is organized in the computer system's storage devices.

Most users equate a desktop to the screen that is first displayed when a computer system is turned on. Note that here “screen” is used to include items such as icons, background image, screen saver image that are displayed as well as video mode settings etc. used to display the items. In any case, each icon is currently displayed with a text label or script that briefly describes the object the icon represents. This text label is invariably positioned below the icon. However, in certain instances, it may not be ideal to display a desktop in this manner.

Thus, what is needed is an apparatus, system and method of configuring a desktop based on a direction in which the script is to be displayed.

### SUMMARY OF THE INVENTION

The present invention provides a system, apparatus and method of configuring a desktop based on text labels' directional properties. The desktop includes a plurality of icons associated each with a text label. The text labels are used to describe the icons. The system, apparatus and method entail determining the directional property of the text labels and configuring the desktop based on the determined directional property. A different configuration is used for each different directional property. For example, if the directional property of the text labels is from left-to-right a first configuration is used. If instead the directional property of the text labels is right-to-left, a second configuration is used. Further, if the directional property of the text labels is top-to-bottom a third configuration is used.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary block diagram illustrating a distributed data processing system according to the present invention.

FIG. 2 is an exemplary block diagram of a server apparatus according to the present invention.

FIG. 3 is an exemplary block diagram of a client apparatus according to the present invention.

FIG. 4 depicts a display of a GUI used to access a desktop.

FIG. 5 illustrates a display of a GUI used to create items on a desktop.

FIG. 6 depicts a display of a GUI used to create items on a desktop used by the invention.

FIG. 7 depicts a plurality of icons/text alignment options used by the invention.

FIG. 8 depicts a first icon/text alignment in accordance with the invention.

FIG. 9 depicts a second icon/text alignment in accordance with the invention.

FIG. 10 depicts a list of ISO-8859 family of character sets.

FIG. 11 is a table cross-referencing character sets with directional properties of languages that may be used by the invention.

FIG. 12 is a flow chart of a process that may be used to implement the invention.

### DETAILED DESCRIPTION OF THE PREFERRED EMBODIMENT

In the past decade, there has been a trend toward shifting from mainframe or host-centric computing to a distributed client-server approach. Lately, this trend has been shifting more and more toward a network-centric or cluster computing approach. In a cluster computing environment, computer systems on a network share a common storage system. This common storage system is generically referred to as a network storage. In view of the above trend, therefore, the invention may reside on a server or a client or personal computer system.

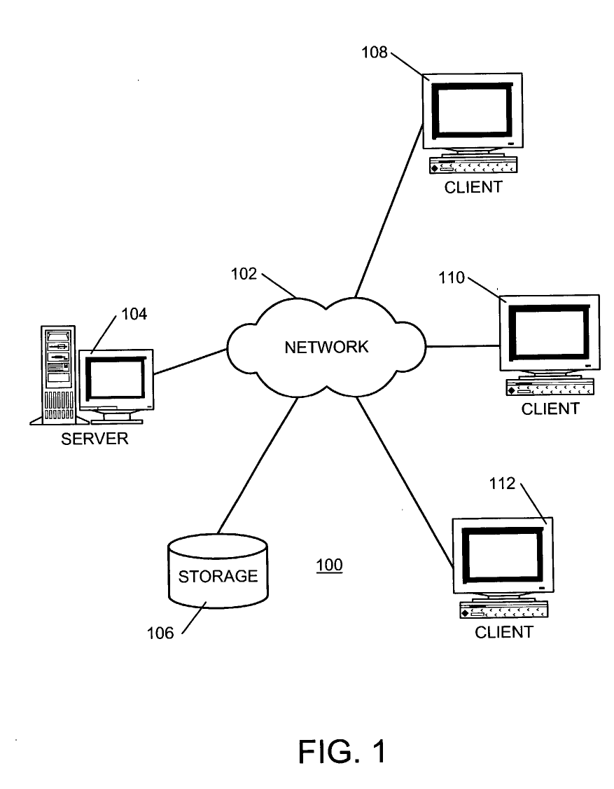

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as boot files, operating system images, and applications to clients 108, 110 and 112. Clients 108, 110 and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

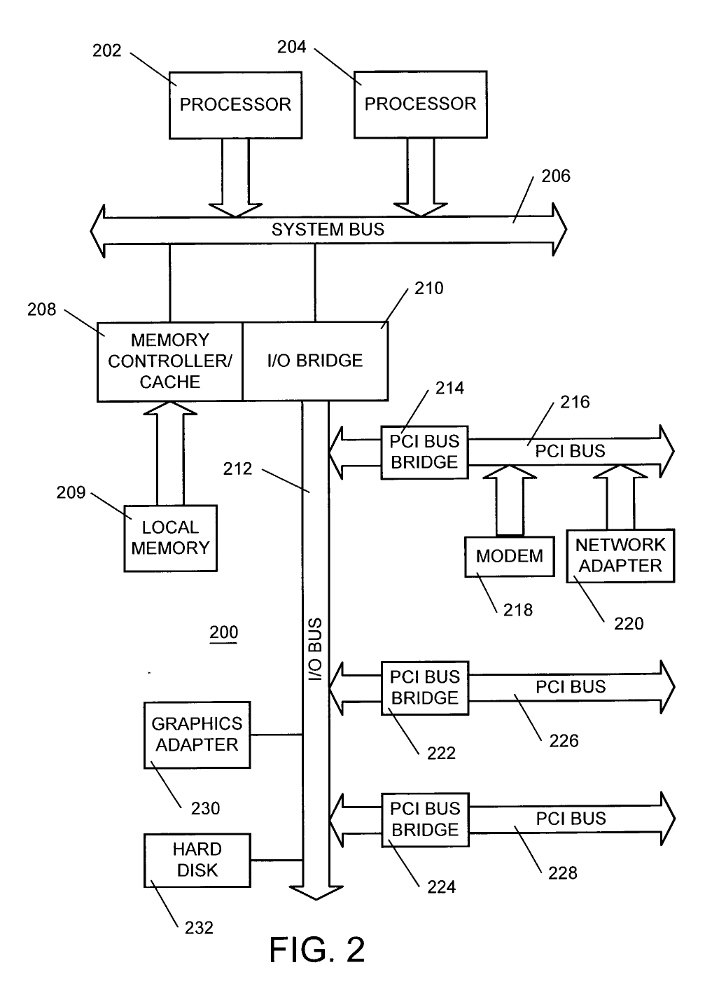

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to network computers 108, 110 and 112 in FIG. 1 may be provided through modem 218 and network adapter 220 connected to PCI local bus 216 through add-in boards. Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM e-Server pSeries system, a product of International Business Machines Corporation in Armonk, New York, running the Advanced Interactive Executive (AIX) operating system or LINUX operating system.

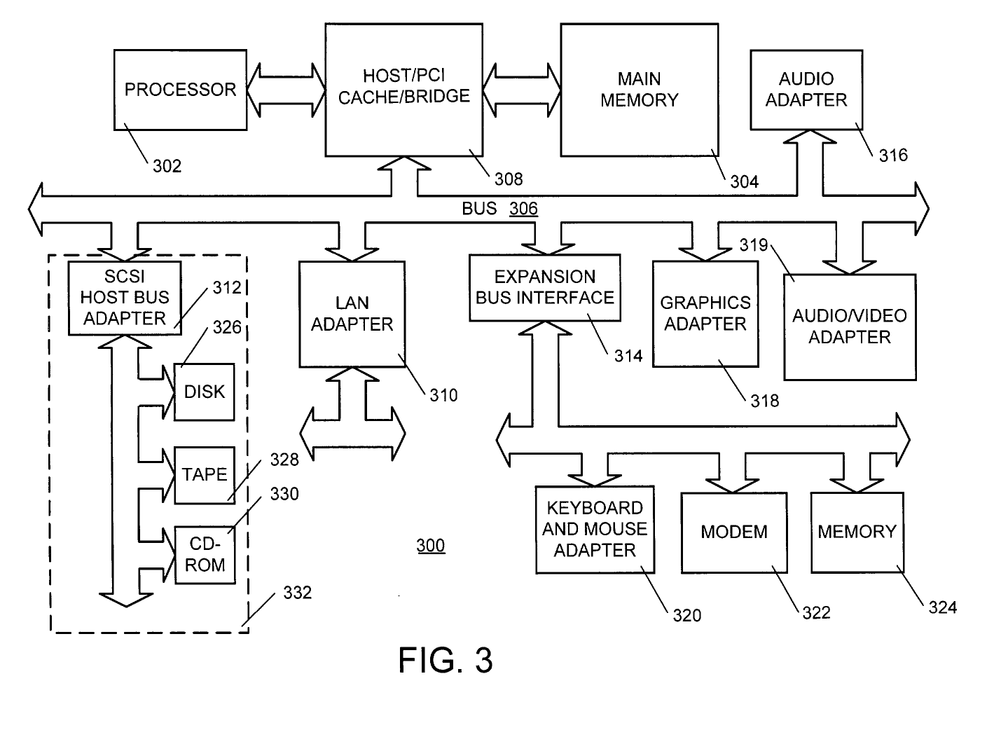

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 may also be a notebook computer or hand held computer in addition to taking the form of a PDA. Data processing system 300 also may be a kiosk or a Web appliance.

The present invention provides an apparatus, system and method of configurationally placing text labels describing icons at a location next to the icons. The invention may be local to client systems 108, 110 and 112 of FIG. 1 or to the server 104 or to both the server 104 and clients 108, 110 and 112. Further, the present invention may reside on any data storage medium (i.e., floppy disk, compact disk, hard disk, ROM, RAM, etc.) used by a computer system.

For illustration purposes, the invention will be described using the Windows operating system. However, it should be understood that the invention is not restricted to this operating system. Any other operating system may be used with the invention and is within the scope and spirit of the invention.

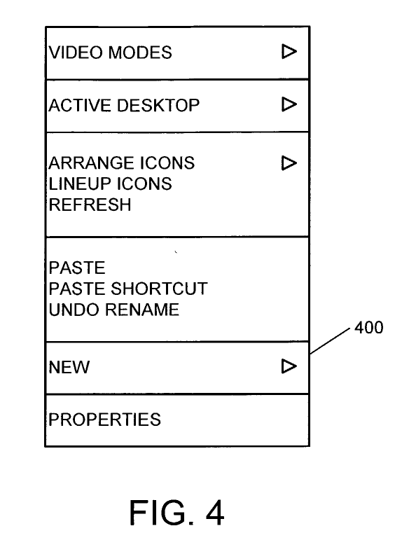

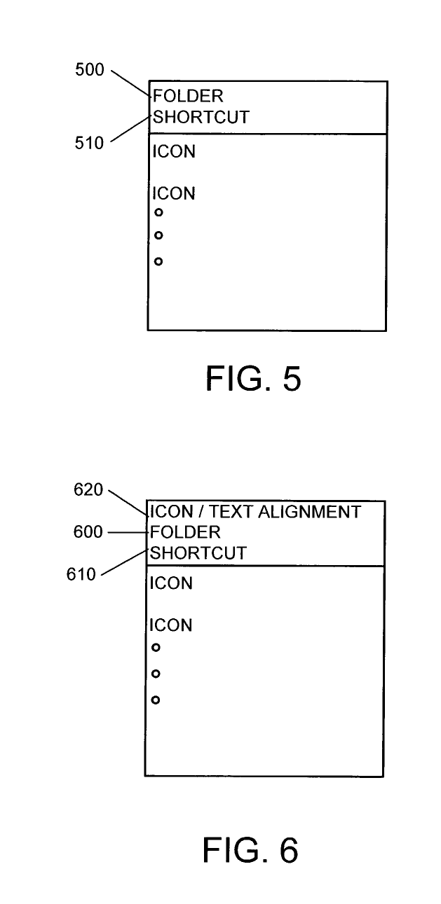

Generally, to access and make changes to the desktop, a user needs to depress the right button of a mouse while the desktop is displayed. When this is done, FIG. 4 is displayed. New item 400 allows a user to create a new folder, create a shortcut (i.e., linking an icon to the program the icon represents) and add new icons to the desktop. FIG. 5 depicts a menu that is displayed when the mouse is on new item 400. In FIG. 5, when a user clicks on folder 500, a new folder is created on the desktop. Likewise, if a user clicks on shortcut 510, the user can point to the location where the item is located such that an icon may be linked to the item.

The invention adds one more item (an icon/text alignment) to FIG. 5. In FIG. 6, icon/text alignment 620 is displayed. When a user asserts icon/text alignment 620, a window may pop open displaying a plurality of available options. Having windows popped open with different options is well known in the field and thus will not be explained.

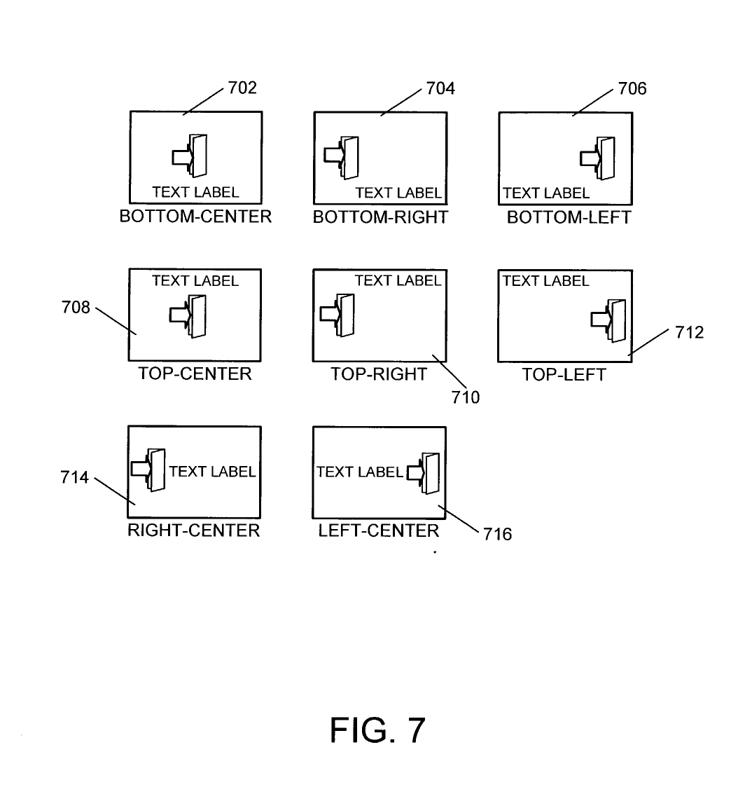

FIG. 7 depicts the icon/text alignment options that may be available to a user (i.e., icon/text alignment options 702-716). If the user chooses icon/text alignment option 702, then the icons on the desktop will be displayed with their text labels centered at the bottom of the window in which they are displayed. If instead, the user chooses text/alignment option 710, the icons will be displayed with their text labels placed at the top right of the windows and so on.

Presently, the icons are displayed in a grid-like fashion on a desktop. Specifically, the screen is divided into a plurality of cells or windows and each icon is placed at the center of a window. The text label of each icon is then placed at the bottom-center of the window in which the icon is located.

In the present invention, the screen is also divided into a plurality of widows. However, the location where the icons are placed into the windows is based upon the location where the text labels are to be placed. Particularly, if the icon/text alignment of a desktop is bottom-right, top-right or right-center (i.e., icon/text alignment option 704, 710 or 714), the icons will be placed to the left of the text labels in the windows. If instead, the icon/text alignment of a desktop is bottom-left, top-left or left-center (i.e., icon/text alignment option 706, 712 or 716), the icons will be placed to the right of the text labels. In the case where the icon/text alignment is top-center or bottom-center (i.e., icon/text alignment option 702 or 708), the icons will be placed in the middle of the windows.

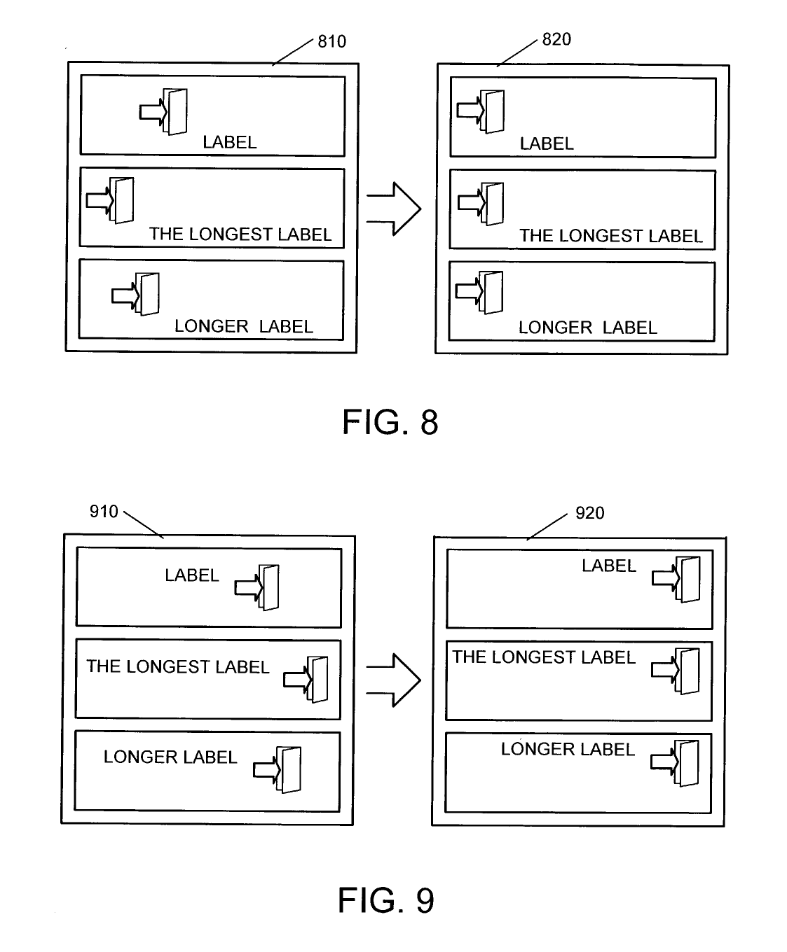

Further, to ensure that the desktop is displayed in an aesthetic fashion, the present invention ensures that all icons on a desktop are placed at the same location in their respective windows. For example, a desktop configured to have the text labels placed to the right of the icons (see desktop 810 of FIG. 8) will have all the icons placed at a particular location on the far left of the windows as shown in desktop 820. Likewise, a desktop configured to have the text labels placed to the left of the icons, as is for example desktop 910 of FIG. 9, will have all the icons placed at a particular location on the far right of the windows as shown in desktop 820. Note that in FIG. 8 a desktop with a bottom-right icon/text alignment (i.e., icon/text alignment option 704) is displayed while in FIG. 9 a desktop with a top-left icon/text alignment (i.e., icon/text alignment option 712) is displayed.

In certain instances, it may be convenient to have the configuration of the icon/text alignment be automatic. For example, when the text labels are written in a language that is written from right-to-left (e.g., Arabic, Hebrew etc.), or top-to-bottom (e.g., traditional Chinese etc.) it may be desirable that the text labels be placed automatically on the left or on the right of the icons, respectively. Accordingly, the invention determines whether the text labels are written from left-to-right as in English or right-to-left as in Arabic or Hebrew or top-to-bottom as in traditional Chinese. To make this determination, the invention may compare letters in text labels to letters in a stored character set. A character set is an encoding algorithm wherein each character or symbol that may be used in a language is assigned a number.

To illustrate, computer text handling involves processing and encoding. For example, when a user enters an uppercase “T” at a keyboard, the computer's system software receives a message that the user pressed a key combination for uppercase “IT”, which it encodes by using a number that represents the letter “T”. The word processor stores the number in memory, and also passes it on to the display software responsible for putting the character on the screen. The display software, which may be a window manager or part of the word processor itself, uses the number as an index to find an image of an uppercase “T”, which it draws on the monitor screen. The process continues as the user types in more characters.

In ASCII (American Standard Code for Information Interchange), the numbers are expressed in octets or bytes. This, then, allows for 256 characters to be represented. However, ASCII only uses the first 128 numbers (i.e., 0-127) or seven (7) bits to represent all characters and/or symbols. Numbers 128-255 are not used. This allows software programs to use the first, most significant bit of a byte as a parity bit, for example. Note that the numerical values of the characters are presented here in the normal (decimal) notation, but other presentations may be used, especially octal (base 8) or hexadecimal (base 16) notation.

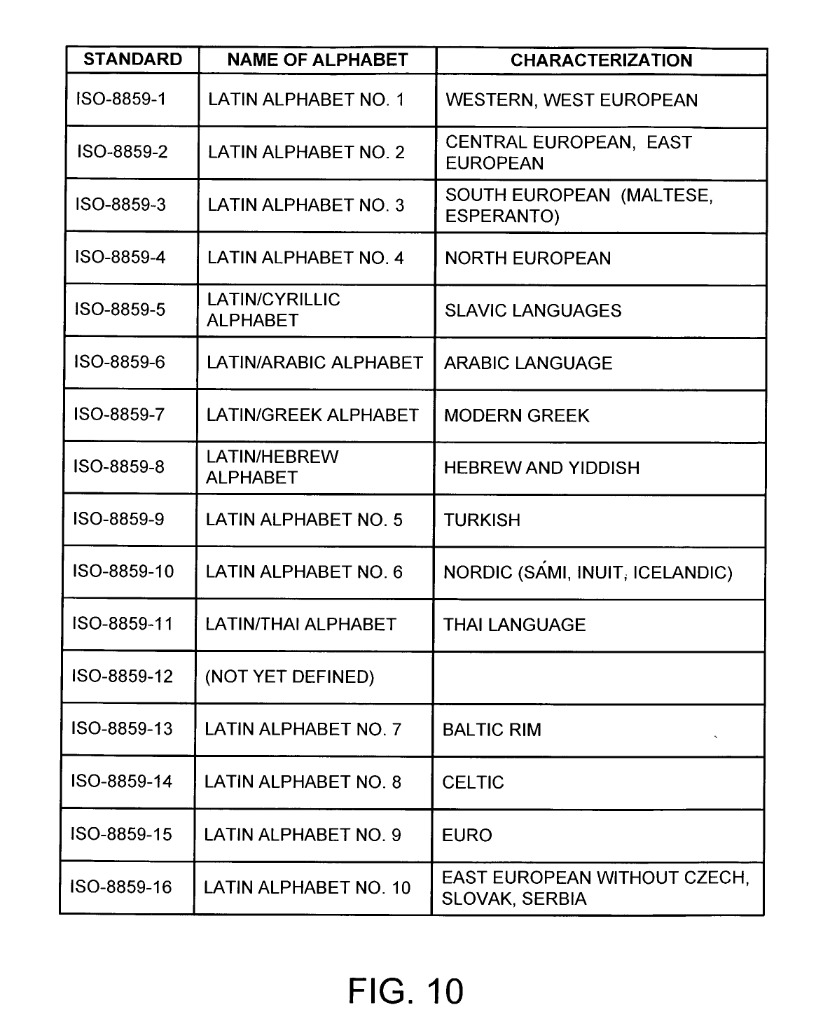

Previously, the ASCII encoding was usually assumed by default. Nowadays, ISO-8859-1 (where ISO stands for International Organization for Standardization), which can be regarded as an extension of ASCII, is often the default. ISO-8859-1 is one of a family of character sets having numbers 0-127 being used to represent the same characters as those in ASCII and numbers 128-255 being used to represent characters of other languages. For example, in ISO-8859-1 (or ISO Latin 1) the numbers 128-255 are used to encode various accented characters and other letters/symbols used in languages of Western Europe. The numbers 128-255, in ISO-8859-6, are used to represent Arabic characters, whereas in TSO-8859-8 they are used to represent Hebrew characters. FIG. 10 depicts a list of the ISO-8859 family of character sets and the characters of the languages that are represented by the numbers 128-255.

To determine the language in use and therefore, the direction of the script or text label, the invention first determines the character set that is in use. Then, the invention evaluates the actual letters or symbols used in the script to obtain their encoding values. For example, if the encoding value of a letter or symbol is between 128 and 256, then the character or symbol is in Arabic, in the case of ISO-8859-6, or Hebrew, in the case of ISO-8859-8. Hence, the direction of the script is from right-to-left. If the encoding value of the character or symbol is between zero (0) and 127, it is instead in English and the direction should be from left-to-right.

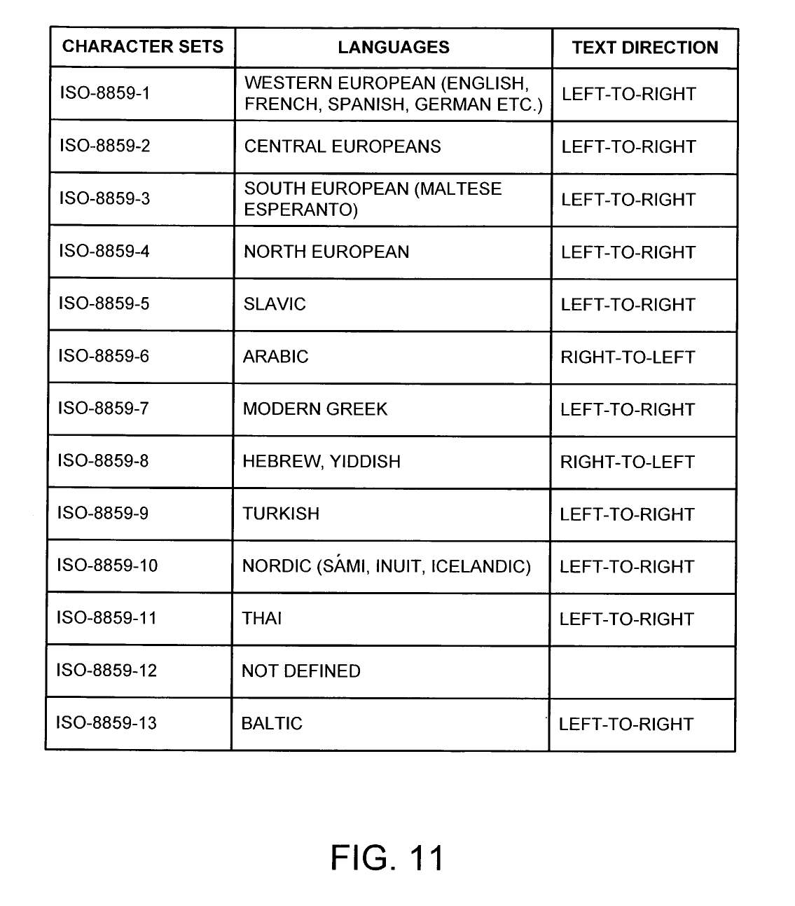

FIG. 11 is a table cross-referencing character sets with directional properties of languages that may be used by the invention. When a computer system is turned on or reset, the invention may query the operating system for the character set that is in use. After obtaining the character set and evaluating the letters in the text labels, the invention may then determine the direction of the text labels. Once the direction of the text labels is determined, the icons may be properly placed in their windows. For example, if the text labels are written in Arabic or Hebrew, the icons may automatically be placed on the far right of the windows. If, on the other hand, the text labels are written in a top-to-bottom direction as in traditional Chinese, the icons may be placed automatically on the far left of the windows. In the present invention, only the first letter in the text labels needs be evaluated to determine the direction of the text.

Note that although the invention is explained using the ISO-8859 family of character sets, it is not thus restricted. Many other character sets may be used and are within the scope and spirit of the invention. For example, Windows character codes are sometimes used instead of the ISO-8859 family of character sets (e.g., Windows-1252 is sometimes used instead of ISO-8859-1 and Windows-874 instead of ISO-8859-11 etc.). In addition, Shift-JIS, ISO-2022-JP or EUC-JP may be used to encode Japanese characters and symbols. Chinese characters and symbols may be encoded using GB2312 (simplified Chinese) or Big5 (traditional Chinese) etc. Korean characters and symbols may be encoded using EUC-KR etc.

Further, Unicode, which encodes all characters and/or symbols used by all languages dead or presently is use in the world, is beginning to be used more and more for encoding purposes. The Unicode specification assigns directionality to Unicode characters and defines an algorithm for determining the proper directionality of text. Consequently, just as in the case of the ISO-8859 family of character sets, the direction of text labels encoded using the Unicode character set may also be determined.

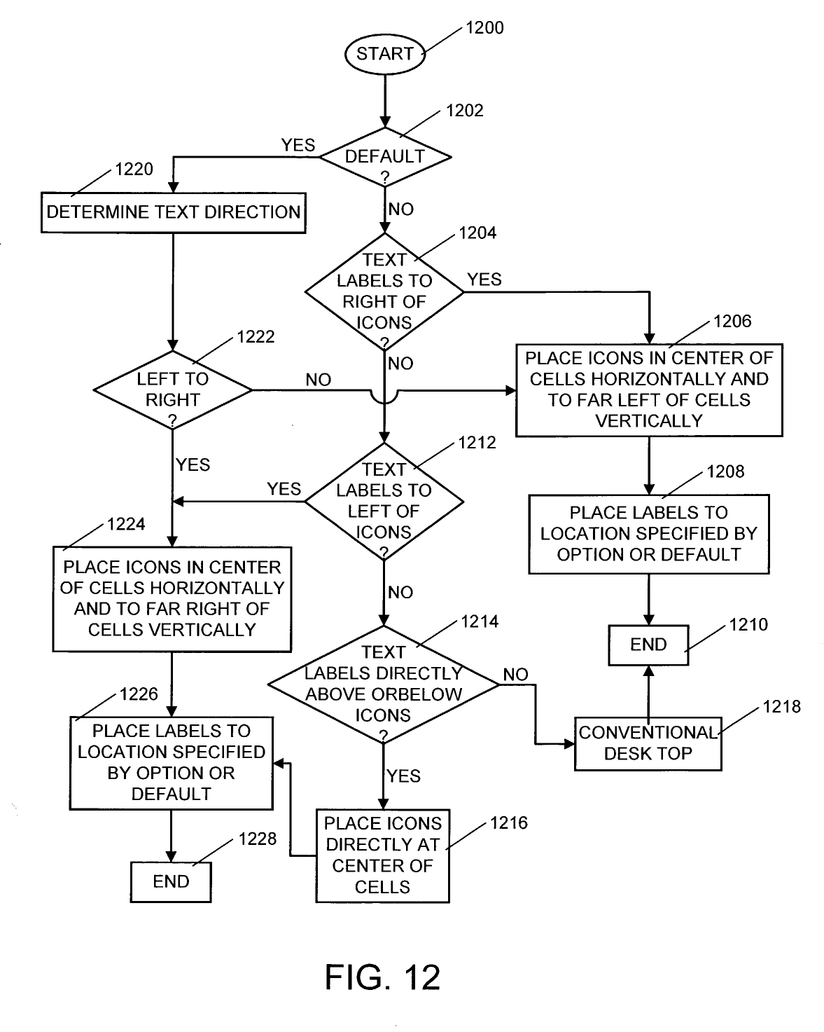

FIG. 12 is a flow chart of a process that may be used to implement the invention. The process starts when a computer system is turned on or is refreshed (step 1200). Then a check is made to determine whether the user has already set the system to or already selected an icon/text alignment option. If so, another check is made to determine whether the text labels are to appear on the right of the icons. If so, then the icons are placed in the center of the cells horizontally and to the far left of the cells vertically and the text labels are placed at the location specified by the option and the process ends (steps 1202, 1204, 1206, 1208 and 1210).

If the text labels are not to be placed to the right of the icons, another check is made to determine whether they are to be placed to the left of the icons. If so, the icons are then placed in the center of the cells horizontally and to the far right of the cells vertically and the text labels are placed at the location specified by the option and the process ends (steps 1204, 1212, 1224, 1226 and 1228).

If the text labels are not to be placed to the left of the icons, another check is made to determine whether they are to be placed either below or above the icons. If so, the icons are then placed in the center of the cells and the text labels are placed at the location specified by the option and the process ends (steps 1212, 1214, 1216, 1226 and 1228). If the text labels are not to be placed either above or below the icons, conventional default option (i.e., icon/text alignment option 702) may be used and the process ends (steps 1214, 1218 and 1210). Note that in this case steps 1212, 1214, 1216, 1226 and 1228 will be followed.

If from step 1202 it is determined that the user has not already set the system to (i.e., already selected) an icon/text alignment option, a determination of the text direction may automatically be made. If it is determined that the language in which the text labels are written is a left-to-right language or top-to-bottom, the process will continue to steps 1224, 1226 and 1228. If, on the other hand, it is a right-to-left language, the process will continue to steps 1206, 1208 and 1210.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method of configuring a desktop, the desktop including a plurality of icons, each icon being associated with a text label having a directional property, the method comprising the steps of:
determining the directional property of the text label; and
configuring the desktop based on the determined directional property of the text label.

2. The method of claim 1 wherein the determining step includes the step of determining the language in which the text label is written.

3. The method of claim 2 wherein the language is encoded using a character set.

4. The method of claim 1 wherein if the directional property of the text label is left-to-right a first default configuration is used.

5. The method of claim 1 wherein if the directional property of the text label is from right-to-left a second default configuration is used.

6. The method of claim 1 wherein if the directional property of the text label is top-to-bottom a third default configuration is used.

7. A method of displaying a desktop, the desktop including a plurality of icons, each icon being associated with a text label, the method comprising the steps of:
determining a direction in which the text label is to be displayed;
configuring the desktop based on the display direction of the text label; and
displaying the desktop.

8. The method of claim 7 wherein the desktop is displayed with all icons making up the desktop placed at the same relative location in their respective windows.

9. The method of claim 8 wherein the text labels each describe the associated icons and are placed at the same location relative to the icons.

10. A computer program product on a computer readable medium for configuring a desktop, the desktop including a plurality of icons, each icon being associated with a text label having a directional property, the computer program product comprising:
code means for determining the directional property of the text label; and
code means for configuring the desktop based on the determined directional property of the text label.

11. The computer program product of claim 10 wherein the determining code means includes code means for determining the language in which the text label is written.

12. The computer program product of claim 11 wherein the language is encoded using a character set.

13. The computer program product of claim 10 wherein if the directional property of the text label is left-to-right a first default configuration is used.

14. The computer program product of claim 10 wherein if the directional property of the text label is from right-to-left a second default configuration is used.

15. The computer program product of claim 10 wherein if the directional property of the text label is top-to-bottom a third default configuration is used.

16. A computer program product on a computer readable medium for displaying a desktop, the desktop including a plurality of icons, each icon being associated with a text label, the computer program product comprising:
code means for determining a direction in which the text label is to be displayed;
code means for configuring the desktop based on the display direction of the text label; and
code means for displaying the desktop.

17. The computer program product of claim 16 wherein the desktop is displayed with all icons making up the desktop placed at the same relative location in their respective windows.

18. The computer program product of claim 17 wherein the text labels each describe the associated icons and are placed at the same location relative to the icons.

19. An apparatus for configuring a desktop, the desktop including a plurality of icons, each icon being associated with a text label having a directional property, the apparatus comprising:
means for determining the directional property of the text label; and
means for configuring the desktop based on the determined directional property of the text label.

20. The apparatus of claim 19 wherein the determining means includes means for determining the language in which the text label is written.

21. The apparatus of claim 20 wherein the language is encoded using a character set.

22. The apparatus of claim 19 wherein if the directional property of the text label is left-to-right a first default configuration is used.

23. The apparatus of claim 19 wherein if the directional property of the text label is from right-to-left a second default configuration is used.

24. The apparatus of claim 19 wherein if the directional property of the text label is top-to-bottom a third default configuration is used.

25. An apparatus for displaying a desktop, the desktop including a plurality of icons, each icon being associated with a text label, the apparatus comprising:
means for determining a direction in which the text label is to be displayed;
means for configuring the desktop based on the display direction of the text label; and
means for displaying the desktop.

26. The apparatus of claim 25 wherein the desktop is displayed with all icons making up the desktop placed at the same relative location in their respective windows.

27. The method of claim 26 wherein the text labels each describe the associated icons and are placed at the same location relative to the icons.

28. A system for configuring a desktop, the desktop including a plurality of icons, each icon being associated with a text label having a directional property, the system comprising:
at least one storage device for storing code data; and
at least one processor for processing the code data to determine the directional property of the text label, and to configure the desktop based on the determined directional property of the text label.

29. The system of claim 28 wherein the processor further processes the code data to determine the language in which the text label is written.

30. The system of claim 29 wherein the language is encoded using a character set.

31. The system of claim 28 wherein if the directional property of the text label is left-to-right a first default configuration is used.

32. The system of claim 28 wherein if the directional property of the text label is from right-to-left a second default configuration is used.

33. The system of claim 28 wherein if the directional property of the text label is top-to-bottom a third default configuration is used.

34. A system for displaying a desktop, the desktop including a plurality of icons, each icon being associated with a text label, the system comprising:
at least one storage device for storing code data; and
at least one processor for processing the code data to determine a direction in which the text label is to be displayed, to configure the desktop based on the display direction of the text label, and to display the desktop.

35. The system of claim 34 wherein the desktop is displayed with all icons making up the desktop placed at the same relative location in their respective windows.

36. The system of claim 35 wherein the text labels each describe the associated icons and are placed at the same location relative to the icons.
